(19) United States
(12) Patent Application Publication
(10) Pub. No.: US 2002/0166895 A1
(43) Pub. Date: Nov. 14, 2002

(54) Charge card purchase

(76) Inventors: Linus Wiebe, Malmo (SE); Petter Ericson, Malmo (SE); Christer Fahraeus, Lund (SE)

Correspondence Address: NORMAN H. ZIVIN, Cooper & Dunham LLP, 1185 Avenue of the Americas, New York, NY, 10036, US

(21) Appl. No.: 09/746,779

(22) Filed: Dec. 22, 2000

Related U.S. Application Data
(60) Provisional application No. 60/177,304, filed on Jan. 21, 2000.
(60) Provisional application No. 60/207,828, filed on May 30, 2000.

(30) Foreign Application Priority Data
Dec. 23, 1999 (SE) 9904746-6
Mar. 21, 2000 (SE) 0000946-4

(51) Int. Cl. G06K 7/10

(52) U.S. Cl. 235/472.01

(57) ABSTRACT

An arrangement for handling charge card purchases has a digital pen (1; 1′) which is arranged to record the signature of a charge card purchaser in digital form when the purchaser writes the signature on a physical charge card receipt (2; 40) using a pen point (17) arranged on the digital pen. The arrangement also has a signal-processing means (16; 33) which is arranged to produce a digital charge card receipt, which corresponds to the physical charge card receipt, by storing the digital signature together with digital purchase information relating to the charge card purchase to which said physical charge card receipt relates. A charge card receipt and a method of handling charge card purchases are also disclosed.

### FIELD OF THE INVENTION

The present invention relates to an arrangement for handling charge card purchases, a method of handling charge card purchases, and a charge card receipt.

### BACKGROUND OF THE INVENTION

For a charge card purchase to be effected, it is usually necessary for the purchaser to present his charge card and to confirm the purchase with his signature on a charge card receipt which contains information about the purchase, for example the cost of the purchase and the number of the charge card.

The charge card receipt may be a preprinted charge card receipt on which the seller fills in information about the purchase by hand. Certain information, such as the charge card number, can be added by an impression being made of the charge card itself using a special device. When the purchaser has signed the charge card receipt, he receives a copy of the receipt, while the seller retains the original. The original is subsequently sent to the bank of the seller, where the information from the charge card receipt is input into a computer and forms the basis for the transfer of money from the account of the purchaser to the account of the seller.

This handling of charge card receipts has the disadvantage that it is entirely manual with all that this involves in terms of the risk of error and time-consuming physical handling of the receipts. The seller may, for example, happen to write incorrect information on the receipt, and the bank may happen to input incorrect information into its computer system.

Some sellers have a charge card reader connected to a cash register, which makes possible a certain simplification of the handling. When a purchaser wishes to make a charge card purchase, the seller draws the charge card through the charge card reader which reads charge card information from the charge card and sends it to the cash register which prints out a charge card receipt which the purchaser can.sign. This considerably reduces the risk of errors associated with the issue of receipts. In some cases, the purchaser keeps a copy of the signed receipt, and the seller retains the original. In other cases, the purchaser signs a receipt which the seller retains, while the purchaser receives another receipt which indicates that the purchase was effected by charge card but which does not have a copy of the signature of the purchaser. In both these cases, information about the charge card purchase can be sent to the bank in digital form.

Nevertheless, the seller or the bank still has to store the physical charge card receipts as proof in case a purchaser subsequently claims he did not make a purchase which has been charged to his account.

In a further variant, the purchaser confirms the purchase by indicating his PIN code on a keyboard. In this case, all the charge card receipt information is sent to the bank in digital form. However, the security is not as great because it is easier to find out the PIN code belonging to a charge card than to forge the signature of the owner.

### SUMMARY OF THE INVENTION

One object of the present invention is to completely or partly remedy the problems described above.

This object is achieved by an arrangement according to claim 1, a method according to claim 18, and a charge card receipt according to claim 22.

More specifically, according to a first aspect of the invention, an arrangement for handling charge card purchase is provided, which comprises a handheld device, preferably a digital pen, which is arranged to record the signature of a charge card purchaser in digital form when the purchaser writes the signature on a physical charge card receipt using a pen point arranged on the handheld device, and a signal-processing means which is arranged to produce a digital charge card receipt, which corresponds to the physical charge card receipt, by storing the digital signature together with digital purchase information relating to the charge card purchase to which said physical charge card receipt relates.

One advantage of this arrangement is that the purchaser can confirm the purchase with his signature on a physical charge card receipt which he can retain, and yet the seller does not have to devote himself to the time-consuming handling of physical charge card receipts. Instead, a digital charge card receipt is created, which contains the signature of the purchaser and therefore corresponds fully to and replaces the original physical charge card receipt. More particularly, the digital charge card receipt comprises all information that is added by hand and/or machine on the physical charge card receipt in connection with the purchase.

A further advantage of the arrangement according to the invention is that it does not require any fundamental changes to the existing infrastructure for handling charge card receipts. The only change which the purchaser will notice is that he has to use a digital pen or other handheld device instead of an ordinary pen. For banks, the change consists in that it is no longer necessary to input charge card purchase information manually because the information is received in digital form They no longer have to store physical charge card receipts either. The seller is also spared the handling of physical charge card receipts.

The handheld device is preferably provided by the seller and designed to be used at the seller's premises. The handheld device could, however, also belong to the user.

The signal-processing means can be integrated in the handheld device. It could comprise a software program to be executed by a processor. It could also be realised in hardware by means of an ASIC (Application Specific Integrated Circuit) or an FPGA (Field Programmable Gate Array). The signal processing means could also be partly or wholly realised in a unit separate from the handheld device.

The term charge card as used in the present application can be a credit card, a debit card or any other card or physical unit which can be used to effect purchases and requires a signature from the owner as confirmation of the purchase. The charge card purchase can relate to a product or a service.

The arrangement according to the invention can advantageously be used by sellers who previously handled charge card purchases entirely manually by means of pre-printed physical charge card receipts. In this case, the handheld device can be arranged to record further information in digital form when the purchaser writes the further information using the handheld device on the physical charge card receipt, this further information in digital form constituting at least in part said digital o purchase information which is stored by the signal-processing unit.

The handheld device can therefore be used to record all the information filled in manually on a preprinted physical charge card receipt. If required, the signal-processing means can supplement the information filled in manually with e.g. date and time, the name of the seller, the serial number of the charge card receipt, a unique pen identifier (pen ID) or similar information.

The handheld device can be of various types. It can, for example, contain an acceleration sensor or gyrosensor which records the movement of the device when the purchaser writes with it. In an advantageous embodiment, however, the handheld device comprises an optical sensor for recording images of the surface of the physical charge card receipt when the purchaser writes on it with the handheld device. No moving parts or complicated sensors are thus required.

The recording of what the purchaser writes can be carried out by recording a plurality of images with partly overlapping contents and determining the relative position of these images as described in international patent application WO 99/60467, which is hereby incorporated by reference.

However, the arrangement expediently comprises means for identifying a position-coding pattern in said images and for converting the position-coding pattern in each image into coordinates for the position of the handheld device on the physical charge card receipt when the image was recorded. Thus, what the purchaser writes on the physical charge card receipt can be stored in a memory in the form of a sequence of coordinates by the signal-processing means.

In this case, the charge card receipt is thus provided with an absolute position-coding pattern which codes the coordinates for a plurality of absolute positions on the charge card receipt so that what the purchaser writes on the charge card receipt can be recorded by continuous reading of the position-coding pattern. The signature written on the charge card receipt is thus recorded in such a way that it can be reproduced graphically, e.g. on a computer screen. Furthermore, the sequence of co-ordinates making up the signature also makes it possible to determine exactly where on the charge card receipt the signature was written. This feature makes the comparison of the digital charge card receipt with the original physical charge card receipt as secure as the traditional comparison of the customer's copy of the charge card receipt with the original physical charge card receipt.

The means for identifying and converting the position-coding pattern into coordinates can be accomplished by means of a processor and suitable software in the handheld device. Alternatively, the means can be formed as a part of the signal-processing means which can in turn be integrated with the handheld device or a physically separate means. In the latter cases, the handheld device records only images which are sent to and processed in the signal-processing means.

In one embodiment, the arrangement comprises a stock of preprinted physical charge card receipts which are provided with a position-coding pattern on at least part of their surface.

These preprinted physical charge card receipts can look exactly like conventional preprinted physical charge card receipts, with the difference that they are provided with a position-coding pattern on at least part of their surface, which part is that part or those parts which is or are to be filled in by means of the digital pen. A further difference is that a copy is not required but a single receipt is sufficient. These preprinted charge card receipts can he used in the same way as the conventional preprinted charge card receipts except for the fact that the required purchase information is filled in using a digital pen or other handheld device.

As an alternative to preprinted physical charge card receipts, the arrangement can make use of charge card receipts which are printed out at the time of purchase. For this purpose, the signal-processing means can be arranged to make a receipt printer print out said physical charge card receipt. The physical charge card receipt printed out expediently comprises information which describes the purchase, such as price, details of the product or service purchased, and charge card number.

The arrangement can comprise a stock of paper, e.g. sheets or reels, which are provided over their entire surface with a position-coding pattern, said sheets or reels being used for printing out said physical charge card receipt. In this case, the paper is thus preprinted with position-coding patterns, and only the purchase information is added.

In an advantageous embodiment, however, the signal-processing means is arranged to make said receipt printer print out a position-coding pattern on at least part of said physical charge card receipt.

The advantage of this embodiment is that ordinary paper of one colour can be used for printing out the receipts. The position-coding pattern is printed out on at least that part of the receipt where the purchaser is to write his signature. If further information is to be filled in by the purchaser or the seller, the position-coding pattern is of course also printed out where this information is to be filled in. The printing could be made in two runs, one with the position-coding pattern and one with the other information,

The arrangement can advantageously be connected to a charge card reader so as to receive a charge card number from the charge card reader, the charge card number constituting part of said digital purchase information. The signal-processing means can thus receive the charge card number and any other information stored on a charge card from the charge card reader and add this information to the digital charge card receipt. Alternatively, the charge card reader can constitute part of the arrangement. The connection can be by way of wires or wireless.

In an advantageous embodiment, the arrangement is connected to a cash register so as to receive at least some of said digital purchase information from the same. In this embodiment, all the purchase information except for the charge card number is obtained from the cash register and can then be printed out on the charge card receipt. Alternatively, the cash register can constitute part of the arrangement itself. Also here the connection can be by way of wires or wireless.

The arrangement can expediently be arranged to send the digital charge card receipt to an external unit, for example a bank. In this way, the entire handling of charge card receipts can take place automatically.

The position-coding pattern described above is advantageously of the types described in the International patent applications Wo 00/73983, PCT/SE00/01895, PCT/SE00/01897 and PCT/SE00/01898, which are incorporated herewith by reference.

According to a second aspect, the present invention relates to a method of handling charge card purchases, comprising the steps of presenting a physical charge card receipt to a purchaser, making the purchaser write his signature on the physical charge card receipt by means of a handheld device, which records the signature digitally when it is being written, and producing a digital charge card receipt which comprises the signature in digital form and digital purchase information.

According to a third aspect, the present invention relates to a charge card receipt comprising at least one writing area which is intended for the signature of a purchaser, the charge card receipt being provided with a position-coding pattern which extends over at least said writing area and makes digital recording of the signature possible.

The advantages of the method and the charge card receipt are evident from the discussion of the arrangement. What has been said about the latter also applies, where appropriate, to the method and the charge card receipt.

### BRIEF DESCRIPTION OF THE DRAWINGS

The present invention will now be described by way of embodiments with reference to the accompanying drawings, in which

FIG. 1 shows schematically a first embodiment of an arrangement according to the invention,;

FIG. 2 shows schematically a second embodiment of an arrangement according to the invention, which is intended for printing out physical charge card receipts at the time of purchase.

FIG. 3 is a schematic view of an enlarged part of a sheet of paper provided with a position-coding pattern, FIG. 4 shows schematically how symbols included in the position-coding pattern can be composed,. and

FIG. 5 is a schematic view of an example of 4×4 symbols that are used to code a position.

### DESCRIPTION OF PREFERRED EMBODIMENTS

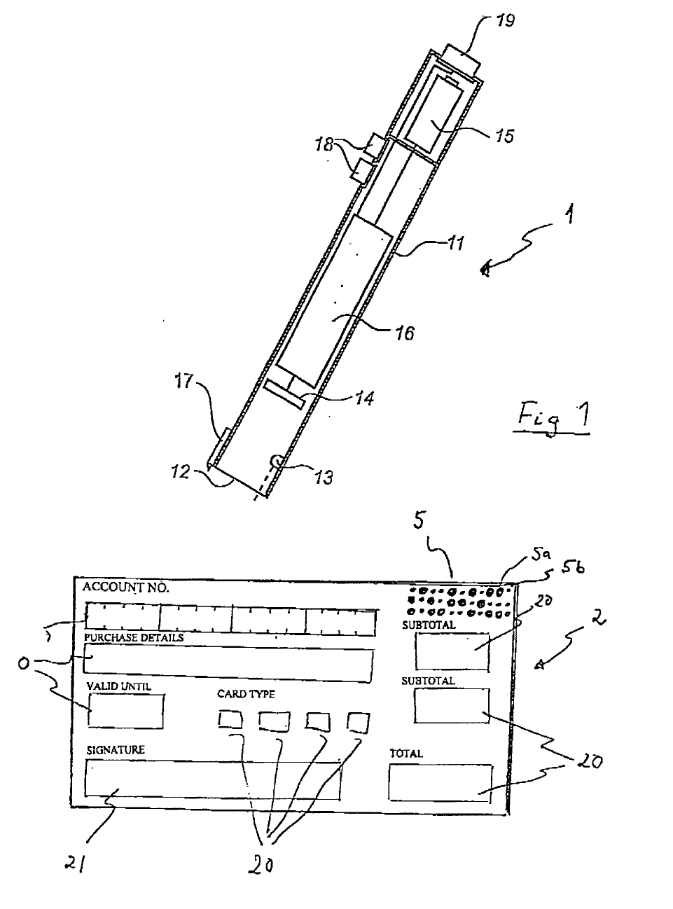

The arrangement shown in FIG. 1 for handling charge card receipts comprises a handheld device in the form of a digital pen 1 as well as a preprinted charge card receipt 2.

The digital pen 1 comprises a casing 11 which is shaped roughly like a pen. There is an opening 12 in the short side of the casing.

The casing accommodates essentially an optical part, an electronic part and a power supply.

The optical part comprises at least one IR-light-emitting diode 13 for illuminating the surface to be reproduced and a light-sensitive area sensor 14, such as a CCD or CMOS sensor, for recording a two-dimensional image. Optionally, the pen can also contain a lens system (not shown). The IR light is absorbed by the position-coding pattern and makes it visible to the sensor in this way.

The power supply for the pen is obtained from a battery 15 mounted in a separate compartment in the casing.

The electronic part contains a processor 16 with an associated memory. The processor is programmed to carry out the functions described below.

The digital pen 1 also comprises a pen point 17, by means of which the user can write ordinary pigment-based writing which is simultaneously recorded digitally by thee digital pen.

The digital pen 1 also comprises buttons 18 by means of which the unit is actuated and controlled. Lastly, it also has a transceiver 19 for wireless short-range communication, for example by IR light or radio waves, with external units.

The charge card receipt 2 is a preprinted charge card receipt. It has a number of writing areas 20. These are intended for various items of purchase information, such as charge card number, details of the purchase and price, which are filled in manually by the seller. It also has a writing area 21 which is intended for the signature of the purchaser.

Printed over the entire surface of the charge card receipt is a position-coding pattern 5. This position-coding pattern 5 has the property that if an arbitrary part of the pattern of a given minimum size is recorded, its position in the position-coding pattern and thus on the charge card receipt can be determined unambiguously.

The position-coding pattern 5 can be of the type disclosed in the above-mentioned U.S. Pat. No. 5,852,434, in which each position is coded by a specific symbol.

However, the position-coding pattern is advantageously of the type disclosed in the above-mentioned international applications, in which each position is coded by a plurality of symbols, and each symbol contributes to the coding of a plurality of positions.

The position-coding pattern is made up of a small number of types of symbol. An example is disclosed in PCT/SP00/01085, in which a larger dot represents a “one” and a smaller dot represents a “zero”. Another example is disclosed in PCT/SE00/01895, in which four different displacements of a dot in relation to a raster point codes four different values. This position-coding pattern is described more in detail below.

FIG. 1 shows the position-coding pattern as being made up of symbols in the form of a larger dot 5a and a smaller dot 5b. For the sake of clarity, the pattern is shown on only a small part of the charge card receipt and at the same time greatly enlarged.

The position-coding pattern on the charge card receipt can constitute a subset of a larger position-coding pattern. The subset codes co-ordinates of points within a specific co-ordinate area, which is a part area of a larger imaginary co-ordinate area, The larger coordinate area corresponds to all the points, the coordinates of which the larger position-coding pattern is capable to code. The subset on the charge card receipt can be dedicated to the seller, so that only that specific seller is entitled to use the subset. Other subsets of the larger position-coding pattern can be dedicated for other sellers. Still further subsets of the larger position-coding pattern can be dedicated for other applications than digital charge card receipts.

If the subset on the digital charge card receipts is A dedicated for a given seller or his business, it is possible, by analysing the co-ordinates which represent a digital signature, to establish subsequently that this digital signature comes from the digital charge card receipt of this given seller, Furthermore, the exact position in which the signature was written on the charge card receipt can be established.

All charge card receipts from a given seller can have the same position-coding pattern. Alternatively, all the receipts from this seller can have unique position-coding patterns which nevertheless belong to a given defined subset of the larger position-coding pattern.

It a unique identifier of the digital pen is included in digital charge card.receipt it is also possible to establish subsequently by which specific digital pen the signature was written.

The arrangement shown in FIG. 1 is used in the following manner. When a charge card purchase is to be effected, the seller takes the preprinted charge card receipt 2 and fills in the charge card number of the purchaser, what the purchase relates to and the total etc. in the writing areas 20 by means of the digital pen 1. While the seller is writing, the optical sensor 14 records continuous images of the surface of the charge card receipt and thus of that part of the position-coding pattern 5 which is located within the field of vision of the sensor 14.

The processor 16 is programmed to record one image at a time from the sensor 14, identify symbols in the image, determine which two coordinates (pair of coordinates) the symbols code and store these coordinates in its memory. The processor 16 is also programmed to analyse stored coordinate pairs and convert these into a polygon train which constitutes a description of how the pen has been moved over the writing areas 20, 21 of the charge card receipt

When the seller has filled in the purchase information on the charge card receipt, the purchaser has to confirm the purchase with his signature in the writing area 21. The signature is also written using the digital pen which records the signature in digital form as a sequence of coordinates. The purchaser then receives the physical charge card receipt as a receipt for the purchase.

The processor 16 also has software which implements a signal-processing means which generates a digital S charge card receipt. Alternatively, the signal-processing means can be accomplished as a physically separate signal-processing unit to which the digital pen is connected. The signal-processing means compiles the purchase information written in the writing areas of the charge card receipt to form a digital charge card receipt which also comprises the signature of the purchaser in digital form and optionally the pen-ID. The information does not have to be filled in in any specific order for the signal-processing means to be capable of identifying which item of information is which. Instead, the signal-processing means can use the coordinates in order to identify which writing area the information is written in. The signal-processing means can also contain ICR (Intelligent Character Recognition) software which interprets the handwritten characters and stores them in character-coded format, for example ASCII format.

The signal-processing means can store a plurality of digital charge card receipts. These can subsequently be transferred to an external unit, for example a computer or a mobile telephone, via the transceiver 19 for storing at the seller's premises and/or for forwarding to the bank of the seller.

In the above-described embodiment, the digital pen is provided by the seller. It is also possible to carry out the purchase by means of a digital pen owned by the purchaser. In this case, the digitally recorded signature and further purchase information may be transmitted to a signal processing means of the seller for further processing and storing.

The information may be transmitted on-line at the time of writing, or delayed, after being stored in the memory of the signal processing means, and transmitted when connection is established with the receiver, such as a bank.

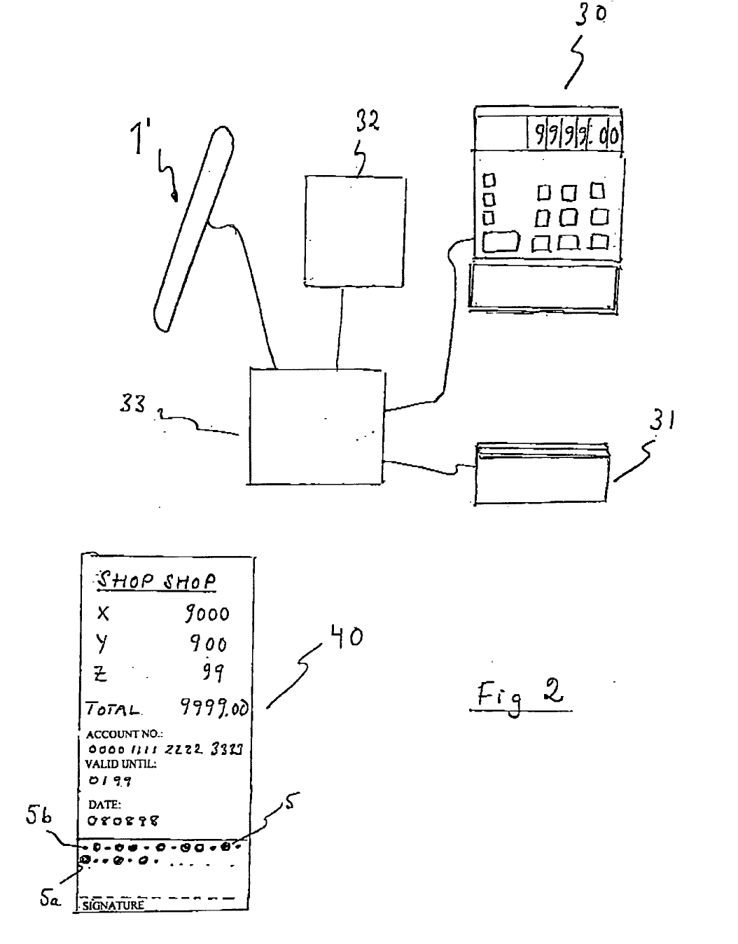

The arrangement shown in FIG. 2 is somewhat more advanced than that in FIG. 1 and can be used for fully automatic handling of charge card purchases. It comprises a digital pen 1′, a cash register 30, a charge card reader 31, a receipt printer 32, and a signal-processing unit 33. The digital pen 1′, the cash register 30, the charge card reader 31 and the receipt printer 32 are all connected to the signal-processing unit 33 by wire or wireless.

The digital pen 1′ is constructed and functions in the same manner as the digital pen 1 in FIG. 1 with the exception that the signal-processing means is, at least partly, implemented as a separate unit.

The cash register 30 is an ordinary cash register. When a user indicates that the recorded purchase information input into the cash register relates to a card purchase, the cash register sends this purchase information to the signal-processing unit 33.

The charge card reader is a conventional charge card reader. When a seller draws a charge card through the reader, the reader reads information stored on the card and sends this charge card information to the signal-processing unit. The charge card information comprises at least the charge card number.

The signal-processing unit 33 comprises a processor A which is programmed to perform the functions described below. When the signal-processing unit receives purchase information about a charge card purchase from the cash register 30 and a charge card number from the charge card reader 31, it stores this information in a file and then instructs the receipt printer 32 to print out a physical charge card receipt 40. The charge card receipt is printed out on white paper. The charge card printer prints out on the one hand the purchase information and the charge card number received and, on the other hand, a position-coding pattern 5 which extends over a part of the receipt 40 where the purchaser is to write his signature. The position-coding pattern is of the same type as described above in connection with FIG. 1.

The printing may take place in one run with both the pattern and the charge card receipt printed at the same time. Alternatively, the charge card receipt may be printed on a paper already provided with the pattern. Another alternative is to first print the pattern with an ink absorbing IR light and then print the charge card receipt in a second run with another ink not absorbing IR-light but absorbing light in the visible range, or vice versa. In this way, the ink used for forming the receipt does not interfere with the IR reading of the pattern.

When the charge card receipt 40 has been printed out, the purchaser confirms the purchase by writing his signature in the intended place by means of the digital pen 1′. The signature is recorded by the digital pen in the manner described in connection with FIG. 1 as a sequence of coordinate pairs. The. coordinate sequence is transferred from the digital pen 1′ to the signal-processing unit 33 which stores the coordinate sequence in the above-mentioned file together with the card number and the purchase information. Optionally, a unique pen identity number (identifier) is transferred from the digital pen and stored in the file. This unique identity number can be used to check subsequently which pen was used to sign the charge card receipt. The items of information stored in the file together form a digital charge card receipt.

When the purchaser has signed the physical charge card receipt, he can retain the same. The digital charge card receipt is sent directly or at a later time to the bank of the seller, where the information is processed in the same manner as in a conventional charge card system. Preferably, the digital charge card receipt is also stored by the seller.

Two embodiments of an arrangement according to the invention and two variants of charge card receipts according to the invention have been described above. Other arrangements and charge card receipts are possible within the scope of the claims. For example, the arrangement does not have to comprise all the units described in FIG. 2; the digital pen and the signal-processing means are sufficient. One or more of the other units in FIG. 2 can then be added. The units shown in FIG. 2 do not have to be physically separate units either, but two or more of them can be integrated with one another. In the embodiment of FIG. 2 the digital pen is provided by the seller. It would also be possible to use an arrangement where the purchaser provides the digital pen. In this case, the digital pen of the purchaser could communicate with the signal-processing unit 33 to transfer the signature and any further purchase information in digital form from the digital pen to the signal-processing unit.

The natural behaviour when writing a charge card receipt is to fill in all details and/or check all details of the receipt and when everything is in order, the receipt is signed and cannot be altered any more. This behaviour may also be used in the present situation. Thus, first all pen strokes on the receipt is registered and stored in a memory and time-stamped. When finally the receipt is signed, the pen waits some seconds and then compiles all pen strokes of the receipt in a file, which is now closed and cannot be further changed, as the A situation is with the physical receipt. Moreover, the completion of the signature is a signal to the pen to send the information to the receiver, by connection with a network in order to transmit the file to e.g. the bank as described above. The completion of the signature may be indicated and a send action be initiated when there is no further pen strokes on the signature area within a few seconds, such as two seconds. Another alternative to indicate that a send action should be undertaken, when the purchaser's pen is used, is the following. When there is no further pen strokes on the signature area within a certain time, such as three seconds, a signature verification software in the pen determines if the signature can be verified to be the signature of the pen owner. Upon positive determination, the above-mentioned file is compiled and closed and a send action is A initiated. Other combinations of these procedures are possible, such as that the file is compiled and closed upon signature verification but the send action is initiated in other ways, such as pressing a button or ticking a send box. When a unique pattern is used for each separate receipt, the identity between the physical receipt and the data receipt can be verified any time after the signing of the receipt, if there should be any dispute about whether the bank or the purchaser have performed their duties. Any tampering with either the physical or digital receipt will be easily found, since then the two copies do not any longer coincide with each other.

As already mentioned, the,.digital charge card receipts are sent by the signal-processing means to the bank or corresponding receiver. The digital charge card receipts can also be logged by the signal-processing means, so that the seller subsequently can prove that the receipts were sent to the bank, Alternatively or as a supplement, the bank may return a copy of the digital charge card receipt as an acknowledgement of the delivery of the receipt.

In the embodiments described above, the digital recording of the signature is carried out by means of a position-coding pattern. As mentioned in the introduction, the recording can also take place by means of some form of sensor in the pen, which detects the movement of the pen. In this case, completely ordinary physical charge card receipts can of course be used.

Finally, the preferred embodiment of the absolute A position-coding pattern will now be described. For the sake of simplicity it is described in connection with a sheet of paper. It corresponds to the absolute position-coding pattern described in PCT/SE/00/01895. It is referred to as a position-coding pattern since a surface to which the position code is applied gives a slightly patterned impression.

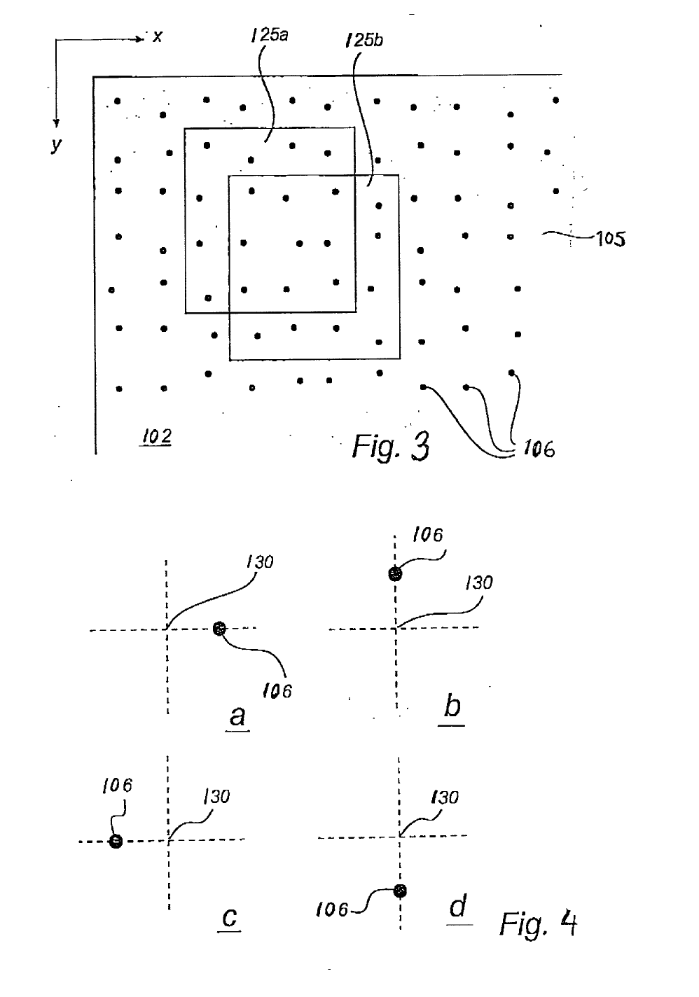

FIG. 3 shows an enlarged part of a sheet which on its surface 102 is provided with the position-coding pattern 105. The sheet has an x coordinate axis and a y coordinate axis.

The position-coding pattern comprises a virtual raster which neither is visible to the human eye nor can be detected directly by a device which is to determine positions on the surface, and a plurality of symbols A which each can assume one of four values “1”-“4” as will be described below.

The position-coding pattern is arranged in such a manner that the symbols on a partial surface of the sheet of paper code absolute coordinates of a point on an imaginary surface, which will be described below. A first and a second partial surface 125a, 125b are indicated by dashed lines in FIG. 3. That part of the position-coding pattern (in this case 4×4 symbols) which is to be found on the first partial surface 125a codes the coordinates of a first point, and that part of the position-coding pattern which is to be found on the second partial surface 125b codes the coordinates of a second point on the imaginary surface. Thus the position-coding pattern A is partially shared by the adjoining first and second points. Such a position-coding pattern is in this application referred to as “floating”.

FIGS. 4a-4d show an embodiment of a symbol which can be used in the position-coding pattern. The symbol comprises a virtual raster point 130 which is represented by the intersection between the raster lines, and a marking 106 which has the form of a dot. The value of the symbol depends on where the marking is located. In the Example in FIG. 4, there are four possible locations, one on each of the raster lines extending from the raster points. The displacement from the raster point is equal to all values. In the following, the symbol in FIG. 4a has the value 1, in FIG. 4b the value 2, in FIG. 4c the value 3 and in FIG. 4d the value 4. Expressed in other words, there are four different types of symbols.

It should be pointed out that the dots can, of course, have a different shape.

Each symbol can thus represent four values “1-4”. This means that the position-coding pattern can be divided into a first position code for the x coordinate, and a second position code for the y coordinate. The division is effected as follows:

| Symbol value | x-code | y-code |
|---|---|---|
| 1 | 1 | 1 |
| 2 | 0 | 1 |
| 3 | 1 | 0 |
| 4 | 0 | 0 |

Thus, the value of each symbol is translated into a first digit, in this case bit, for the x-code and a second digit, in this case bit, for the y-code. In this manner, two completely independent bit patterns are obtained. The patterns can be combined to a joint pattern, which is coded graphically by means of a plurality of symbols according to FIG. 4.

The coordinates for each point is coded by means of a plurality of symbols. In this example, use is made of 4×4 symbols to code a position in two dimensions, i.e. an x-coordinate and a y-coordinate.

The position code is made up by means of a number series of ones and zeros which have the characteristic A that no sequence of four bits appears more than once in the series. The number series is cyclic, which means that the characteristic also applies when one connects the end of the series to the beginning of the series. Thus a four-bit sequence always has an unambiguously determined position in the number series.

The series can maximally be 16 bits long if it is to have the above-described characteristic for sequences of four bits. In this example, use is, however, made of a series having a length of seven bits only as follows: “0 0 0 1 0 1 0”.

This series contains seven unique sequences of four bits which code a position in the series as follows:

| Position in the series | Sequence |
|---|---|
| 0 | 0001 |
| 1 | 0010 |
| 2 | 0101 |
| 3 | 1010 |
| 4 | 0100 |
| 5 | 1000 |
| 6 | 0000 |

For coding the x-coordinate, the number series is writing sequentially in columns across the entire surface that is to be coded. The coding is based on the difference or position displacement between numbers in adjoining columns. The size of the difference is determined by the position (i.e. with which sequence) in the number series, in which one lets the column begin. More specifically, if one takes the difference modulo seven between on the one hand a number which is coded by a four-bit sequence in a first column and which thus can have the value (position) 0-6, and, on the other hand, the corresponding number (i.e. the sequence on the same “level”) in adjonining column, the result will be the same independently of where along the two columns one makes the comparison. By means of the difference between two columns, it is thus possible to code an x-coordinate which is constant for all y-coordinates.

Since each position on the surface is coded with 4×4 symbols in this example, three differences (having the value 0-6) as stated above are available to code the x-coordinate. Then the coding is carried out in such manner that of the differences, one will always have the value 1 or 2 and the other two will have values in the range 3-6. Consequently no differences are allowed to be zero in the x-code. In other words, the x-code is structured so that the differences will be as follows: (3-6) (3-6) (1-2) (3-6) (3-6) (1-2) (3-6) (3-6) (1-2) . . . Each x-coordinate thus is coded with-two numbers between 3 and 6-and a subsequent number which is 1 or 2: If three is subtracted from the high numbers and one from the low, a number in mixed base will be obtained, which directly yields a position in the x-direction, from which the x-coordinate can then be determined directly, as shown in the example below.

By means of the above described principle, it is thus possible to code x-coordinates 0, 1, 2 . . . , with the aid of numbers representing three differences. These differences are coded with a bit pattern which is based on the number series above. The bit pattern can finally be coded graphically by means of the symbols in FIG. 4.

In many cases, when reading 4×4 symbols, it will not be possible to produce a complete number which codes the x-coordinate, but parts of two numbers. Since the least significant part of the numbers is always 1 or 2, a complete number, however, can easily be reconstructed.

The y-coordinates are coded according to the same principle as used for the x-coordinates. The cyclic number series is repeatedly written in horizontal rows across the surface which is to be position-coded. Just like in the case of the x-coordinates, the rows are A allowed to begin in different positions, i.e. with different sequences, in the number series. However, for y-coordinates one does not use differences but codes the coordinates with numbers that are based on the starting position of the number series on each row. When the x-coordinate for 4×4 symbols has been determined, it is in tact possible to determine the starting positions in the number series for the rows that are included in the y-code in the 4×4 symbols. In the y-code the most significant digit is determined by letting this be the only one that has a value in a specific range. In this example, one lets one row of four begin in the position 0-1 in the number series to indicate that this row relates to the least significant digit in a y-coordinate, and the other three begin in the position 2-6. In y-direction, there is thus a series of numbers as follows: (2-6) (2-6) (2-6) (0-1) (2-6) (2-6) (2-6) (0-1) (2-6) . . . Each y-coordinate thus is coded with three numbers between 2 and 6 and a subsequent number between 0 and 1.

If 0 is subtracted from the low number and 2 from the high, one obtains in the same manner as for the x-direction a position in the y-direction in mixed base from which it is possible to directly determine the y-coordinate.

With the above method it is possible to code 4×4×2=32 positions in x-direction. Each such position corresponds to three differences, which gives 3×32=96 positions. Moreover, it is possible to code 5×5×5×2=250 positions in y-direction. Each such position corresponds to 4 rows, which gives 4×250=1000 positions. Altogether it is thus possible to code 96000 positions. Since the x-coding is based on differences, it is, however, possible to select in which position the first number series begins. It one takes into consideration that this first number series can begin in seven different positions, it is possible to code 7×96000=672000 positions. The starting position of the first number series in the first column can be calculated when the x-coordinate has been determined. The above-mentioned seven different starting positions for the first series may code different sheets of paper or writing surfaces on a product.

With a view to further illustrating the function of the position-coding pattern, here follows a specific example which is based on the described embodiment of A the position code.

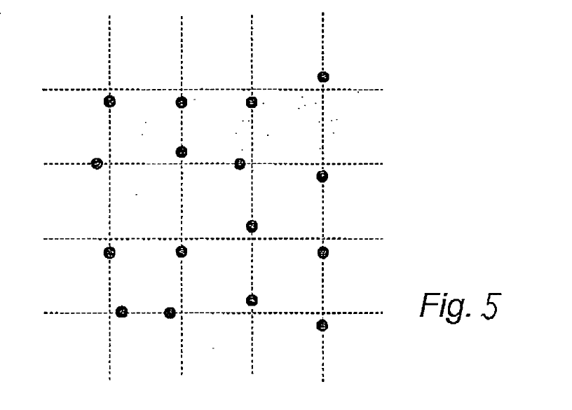

FIG. 5 shows an example of an image with 4×4 symbols which are read by a device for position determination.

These 4×4 symbols have the following values:

| | | | |
|---|---|---|---|
| 4 | 4 | 4 | 2 |
| 3 | 2 | 3 | 4 |
| 4 | 4 | 2 | 4 |
| 1 | 3 | 2 | 4 |

These values represent the following binary x- and y-code:

| | |
|---|---|
| x-code: | y-code: |

| | | | | | | | |
|---|---|---|---|---|---|---|---|
| 0 | 0 | 0 | 0 | 0 | 0 | 0 | 1 |
| 1 | 0 | 1 | 0 | 0 | 1 | 0 | 0 |
| 0 | 0 | 0 | 0 | 0 | 0 | 1 | 0 |
| 1 | 1 | 0 | 0 | 1 | 0 | 1 | 0 |

The vertical x-sequences code the following positions in the number series: 2 0 4 6. The differences between the columns will be −2 4 2, which modulo 7 gives: 5 4 2, which in mixed base codes position (5-3)×8+(4-3)×2+(2-1)=16+2+1=19. since the first coded x-position is position 0, the difference which is in the range 1-2 and which is to be seen in the 4×4 symbols is the twentieth such difference. Since furthermore there are a total of three columns for each such difference and there is a starting column, the vertical sequence furthest to the right in the 4×4 x-code belongs to the 61st column in the x-code (3×20+1=61) and the one furthest to the left belongs to the 58th.

The horizontal y-sequences code the positions 0 4 1 3 in the number series. Since these series begin in the 58th column, the starting position of the rows are these numbers minus 57 modulo7, which yields the starting positions 6 3 0 2. Translated into digits in the mixed base, this will be 6-2, 3-2, 0-0, 2-2=4 1 0 0 where the third digit is the least significant digit in the number at issue. The fourth digit is then the most significant digit in the next number. In this case, it must be the same as in the number at issue. (An exceptional case is when the number at issue consists of the highest possible digits in all positions. Then one knows that the beginning of the next number is one greater than the beginning of the number at issue.)

The position of the four-digit number will then in the mixed base be 0×50+4×10+2+0×1=42.

The third row in the y-code thus is the 43rd which has the starting position 0 or 1, and since there are four rows in all on each such row, the third row is number 43×4=172.

Thus, in this example, the position of the uppermost left corner for the 4×4 symbol group is (58,170).

Since the x-sequences in the 4×4 group begin on row 170, the x-columns of the entire pattern begin in the positions of the number series ((2 0 4 6)−169) modulo 7=1 6 3 5. Between the last starting position (5) and the first starting position, the numbers 0-19 are coded in the mixed base, and by adding up the representations of the numbers 0-19 in the mixed base, one obtains the total difference between these columns. A naive algorithm to do so is to generate these twenty numbers and directly A add up their digits. The resulting sum is called s. The sheet of paper or writing surface will then be given by (5-s) modulo7.

In the example above, an embodiment has been described, in which each position is coded with 4×4 symbols and a number series with 7 bits is used. Of course, this is but an example. Positions can be coded with a larger or smaller number of symbols. The number of symbols need not be the same in both directions. The number series can be of different length and need not be binary, but may be based on another base. Different number series can be used for coding in x-direction and coding in y-direction. The symbols can have different numbers of values. As is evident from the above, a coding with 6×6 symbols is presently preferred, each symbol being capable of assuming four values. A person skilled in the art can readily generalise the above examples to concern such coding.

In the example above, the marking is a dot but may, of course, have a different appearance. For example, it may consist of a dash or some other indication which begins in the virtual raster point and extends. therefrom to a predetermined position. As one more alternative, the marking may consist of a rectangle, a square, a triangle or some other convenient, easily detected figure. The marking can be filled or open.

In the example above, the symbols within a square partial surface are used for coding a position. The partial surface may have a different form, such as hexagonal. The symbols need not be arranged in rows and columns at an angle of 90° to each other but can also be arranged at other angles, e-g. 60°, and/or in other arrangements. They could also code positions in polar coordinates or coordinates in other coordinate systems.

For the position code to be detected, the virtual raster must be determined. This can be carried out by studying the distance between different markings. The shortest distance between two markings must derive from two neighbouring symbols having the value 1 and 3 (horizontally) or 2 and 4 (vertically) so that the markings are located on the same raster line between two raster points. When such a pair of markings has been detected, the associated raster points can be determined with knowledge of the distance between the raster points and the displacement of the markings from the raster points. When two raster points have once been located, additional raster points can be determined by means of measured distances to other markings and with knowledge of the relative distance of the raster points.

The position-coding pattern described above can code a large number of unique positions and more specifically the absolute coordinates of these positions. All the positions or points that can be coded by means of the position-coding pattern can be said to jointly make up an imaginary surface. Different parts of the imaginary surface can be dedicated to different specific purposes. One area of the imaginary surface can, for instance, be dedicated to be used as a writing surface, another as a character recognition area and yet'other areas as various activation icons. Other areas of the imaginary surface can be used in other applications. A corresponding subset of the position-coding pattern can then be used to create, for example, a certain activation icon which can be arranged in an optional location on a product. The coordinates coded by this subset of the position-coding pattern thus do not relate to a position on the product but to a position on the imaginary surface, which position is dedicated always to correspond to this activation icon.

In the presently preferred embodiment, the nominal interspace between the dots is 0.3 mm. Any part whatever of the position-coding pattern which contains 6×6 dots defines the absolute coordinates of a point on the imaginary surface. Each point on the imaginary surface is thus defined by a 1.8 mm×1.8 mm subset of the position-coding pattern. By determining the position of the 6×6 dots on a sensor in a device which is used to read the pattern, a position can be calculated by interpolation on the imaginary surface with a resolution of 0.03 mm. Since each point is coded with 6×6 dots which can each assume one of four values, 2⁷² points can he coded, which with the above-mentioned nominal interspace between the dots corresponds to a surface of 4.6 million km².

The absolute position-coding pattern can be printed on any paper whatever or other material which enables a resolution of about 600 dpi. The paper can have any size and shape whatever depending on the intended application. The pattern can be printed by standard offset printing. Ordinary black carbon-based ink or some other ink which absorbs IR light can advantageously be used. This means in fact that other inks, including black ink which is not carbon-based, can be used to superimpose other printed text on the absolute position-coding pattern, without interfering with the reading thereof.

A surface which is provided with the above-mentioned ed pattern printed with carbon-based black ink will be experienced by the human eye as only a slight grey shading of the surface (1-3% density), which is user-friendly and aesthetically pleasing.

Of course, a smaller or large number of dots than described above can be used to define a point on the imaginary surface and a larger or smaller distance between the dots can be used in the pattern. The examples above are only given to demonstrate a presently preferred implementation of the pattern.

1. An arrangement for handling charge card purchases, characterised by a handheld device (1; 1′) which in arranged to record the signature of a charge card purchaser in digital form when the purchaser writes his signature on a physical charge card receipt (2; 40 ) using a pen point (17) arranged on the handheld device, and a signal-processing means (16; 33) which is arranged to produce a digital charge card receipt, which corresponds to the physical charge card receipt, by storing the digital signature together with digital purchase information relating to the charge card purchase to which said physical charge card receipt relates.

2. An arrangement according to claim 1, wherein the handheld device (1, 1′) is arranged to record further information in digital form when the purchaser writes the further information using the handheld device on the physical charge card receipt (2, 40), this further information in digital form constituting at least in part said digital purchase information which is stored by the signal-processing unit.

3. An arrangement according to claim 1 or 2, wherein the handheld device comprises an optical sensor (14) for recording images of the surface of the physical charge card receipt when the purchaser writes on it with the handheld device.

4. An arrangement according to claim 3, wherein the arrangement comprises means (16) for identifying a position-coding pattern in said images and for converting the position-coding pattern in each image into coordinates for the position of the handheld device on the physical charge card receipt when the image was recorded.

5. An arrangement according to any one of the preceding claims, comprising a stock of blank physical charge card receipts which are provided with a position-coding pattern (5) on at least part of their surface.

6. An arrangement according to any one of claims 1-3, wherein the signal-processing means is arranged to make a receipt printer (32) print out said physical charge card receipt.

7. An arrangement according to claim 6, wherein the signal-processing means is arranged to make said receipt printer print out a position-coding pattern (5) on at least part of said physical charge card receipt (40).

8. An arrangement according to claim 6, wherein the arrangement comprises a stock of papers which are provided over their entire surface with a position-coding pattern, said stock of papers being used for printing out said physical charge card receipts.

9. An arrangement according to any one of the preceding claims, wherein the arrangement is arranged to be connected to a charge card reader (31) to receive a charge card number from the charge card reader, the charge card number constituting part of said digital purchase information.

10. An arrangement according to any one of the preceding claims, wherein the arrangement is arranged to be connected to a cash register (30) to receive at least some of said digital purchase information from the same.

11. An arrangement according to any one of the preceding claims, wherein the arrangement is arranged to send the digital charge card receipt to an external unit.

12. An arrangement according to claim 11, wherein the completion by the purchaser of the signature on the physical charge card receipt triggers the sending of the digital charge card receipt to the external unit.

13. An arrangement according to any one of the preceding claims, wherein the signal processing means is arranged to produce the digital charge card receipt by compiling the digital signature and the digital purchase information in a file.

14. An arrangement according to claim 13, wherein the file is closed for alterations a predetermined time period after that the purchaser has terminated the writing on the physical charge card, receipt.

15. An arrangement according to any one of the preceding claims, wherein the signal processing means is adapted to compare the digital signature recorded by the handheld device with a previously stored signature of the owner of the handheld device to verify the signature.

16. An arrangement according to claim 11 and 15, wherein the verification of the signature triggers the sending of the digital charge card receipt to the external unit.

17. An arrangement according to any one of the preceding claims, wherein the handheld device is a digital pen.

18. A method of handling charge card purchases, comprising the steps of presenting a physical charge card receipt to a purchaser, having a purchaser write his signature on the physical charge card receipt by a handheld device, which records the signature digitally when it is being written, and producing a digital charge card receipt which comprises the signature in digital form and digital purchase information.

19. A method according to claim 18, further comprising the step of providing the physical charge card receipt.

20. A method according to claim 19, further comprising the step of providing the physical charge card receipt with a position-coding pattern.

21. A method according to any one of claims 18-20, further comprising the step of having the purchaser to write further purchase information on the charge card receipt by the handheld device, which records the further information in digital form, this further information in digital form constituting at least in part said digital. purchase information.

22. A charge card receipt comprising at least one writing area (21) which is intended for the signature of a purchaser, characterised in that the charge card receipt is provided with a position-coding pattern which extends over at least said writing area and makes digital recording of the signature possible.

23. A charge card receipt according to claim 22, on which the position-coding pattern is an absolute position-coding pattern, which codes co-ordinates of a plurality of positions on the charge card receipt.

24. The charge card receipt according to claim 22 or 23, comprising further writing areas (20) which are intended for further purchase information and which are provided with the position-coding pattern to make digital recording of the further purchase information possible.

25. The charge card receipt according to any one of claims 22-24, wherein the position-coding pattern comprises a raster and a plurality of symbols, the value of each symbol being determined by the location of a marking in relation to a raster point in the raster.

26. The charge card receipt according to any one of claims 22-25, which charge card receipt for use in an arrangement for handling charge card purchases according to any one of claims 1-17.
